(19) United States
(12) Patent Application Publication
(10) Pub. No.: US 2016/0291183 A1
(43) Pub. Date: Oct. 6, 2016

(54) SYSTEM AND METHOD FOR SEISMIC IMAGING OF COMPLEX SUBSURFACE VOLUMES

(71) Applicants: Chaoshun HU, Houston, TX (US); Leonard Lin ZHANG, Sugarland, TX (US)

(72) Inventors: Chaoshun HU, Houston, TX (US); Leonard Lin ZHANG, Sugarland, TX (US)

(73) Assignee: CHEVRON U.S.A. INC., San Ramon, CA (US)

(21) Appl. No.: 14/676,106

(22) Filed: Apr. 1, 2015

(51) Int. Cl. G01V 1/34; G01V 1/30; G01V 1/36; G01V 1/28

(52) U.S. Cl. CPC G01V 1/345; G01V 1/282; G01V 1/30; G01V 1/362; G01V 2210/51; G01V 2210/671; G01V 2210/74

(57) ABSTRACT

A method is described for seismic imaging of complex subsurface volumes including an optimized partial stack based on ray coverage determined for vector image partition tiles. The method may be executed by a computer system.

### TECHNICAL FIELD

The disclosed embodiments relate generally to techniques for deriving seismic images of the subsurface from geophysical seismic data and, in particular, to a method of deriving a seismic image of a complex subsurface volume using weighted selective stacking.

### BACKGROUND

Seismic exploration involves surveying subterranean geological media for hydrocarbon deposits. A survey typically involves deploying seismic sources and seismic sensors at predetermined locations. The sources generate seismic waves, which propagate into the geological medium creating pressure changes and vibrations. Variations in physical properties of the geological medium give rise to changes in certain properties of the seismic waves, such as their direction of propagation and other properties.

Portions of the seismic waves reach the seismic sensors. Some seismic sensors are sensitive to pressure changes (e.g., hydrophones), others to particle motion (e.g., geophones), and industrial surveys may deploy one type of sensor or both. In response to the detected seismic waves, the sensors generate corresponding electrical signals, known as traces, and record them in storage media as seismic data. Seismic data will include a plurality of “shots” (individual instances of the seismic source being activated), each of which are associated with a plurality of traces recorded at the plurality of sensors.

Seismic data is processed to create seismic images that can be interpreted to identify subsurface geologic features including hydrocarbon deposits. However, all seismic data is contaminated with noise that, even after processing, may obscure volumes of interest in the subsurface. Although many methods for attenuating noise have been developed, problems remain, especially in complex subsurface volumes such as under salt bodies.

There exists a need for improved seismic images that will allow better seismic interpretation of potential hydrocarbon reservoirs.

### SUMMARY

In accordance with some embodiments, a method of seismic imaging may include receiving a seismic dataset representative of a subsurface volume of interest and a velocity model; migrating each of a plurality of shots in the seismic dataset to create a plurality of shot images; assigning each of the plurality of shot images to one of a plurality of vector image partition (VIP) tiles; receiving a local geologic structure for an imaging location in the subsurface volume of interest; raytracing, based on the local geologic structure and the velocity model, from the imaging location to a surface above the imaging location, wherein the surface is defined by locations at which the seismic dataset was acquired; calculating ray coverage in each of the VIP tiles based on the raytracing; assigning weights to each of the VIP tiles based on the ray coverage; stacking the plurality of shot images using the assigned weights to create an partial stack seismic image; and identifying geologic features based on the partial stack seismic image.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates a flowchart of a method of seismic imaging using partial weighted stacking, in accordance with some embodiments.

FIGS. 2A and 2B illustrate vector image tiles and exemplary seismic images residing therein;

FIGS. 3A and 3B illustrate raytracing to vector image tiles and calculating ray coverage therein;

FIGS. 4A and 4B illustrate a conventional seismic image and the improved seismic image resulting from an embodiment of the present invention; and

FIG. 5 is a block diagram illustrating a seismic imaging system, in accordance with some embodiments.

Like reference numerals refer to corresponding parts throughout the drawings.

### DETAILED DESCRIPTION OF EMBODIMENTS

Described below are methods, systems, and computer readable storage media that provide a manner of seismic imaging. These embodiments are designed to be of particular use for seismic imaging of subsurface volumes in geologically complex areas such as under or near salt bodies and faults.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

Seismic imaging of the subsurface is used to identify potential hydrocarbon reservoirs. Seismic data is acquired at a surface (e.g. the earth's surface, ocean's surface, or at the ocean bottom) as seismic traces which collectively make up the seismic dataset. In general, a seismic dataset includes thousands or even millions of traces, each associated with a particular shot. However, not all of those traces contain signal that represent a particular image point of interest in the subsurface. The present invention provides embodiments for identifying seismic data that does include such signal and using it to construct a seismic image.

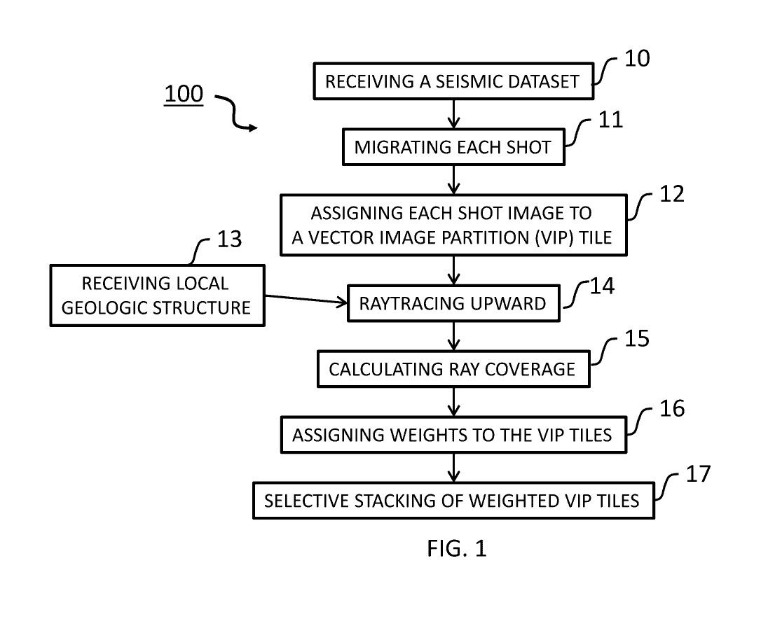

FIG. 1 illustrates a flowchart of a method 100 for seismic imaging of a complex subsurface volume of interest. At operation 10, a seismic dataset is received. As previously described, the seismic dataset includes a plurality of shots, each associated with a plurality of traces recorded at a plurality of seismic sensors. This dataset may have already been subjected to a number of seismic processing steps, such as deghosting, multiple removal, spectral shaping, and the like. These examples are not meant to be limiting. Those of skill in the art will appreciate that there are a number of useful seismic processing steps that may be applied to seismic data before it is deemed ready for migration.

At operation 11, each shot of the seismic dataset is migrated. This means that the traces associated with a single shot are migrated to create a single shot image. Seismic migration is known to those of skill in the art as a way to move the recorded signal in the traces to a location physically representative of where that signal was reflected from in the subsurface (i. e., an image point). The migration algorithm may be a shot-domain prestack Gaussian beam migration method or a reverse time migration (RTM) method. In general, migration requires the use of a velocity model, which would have been generated prior to this operation, likely during the seismic processing that took place prior to the steps of method 100.

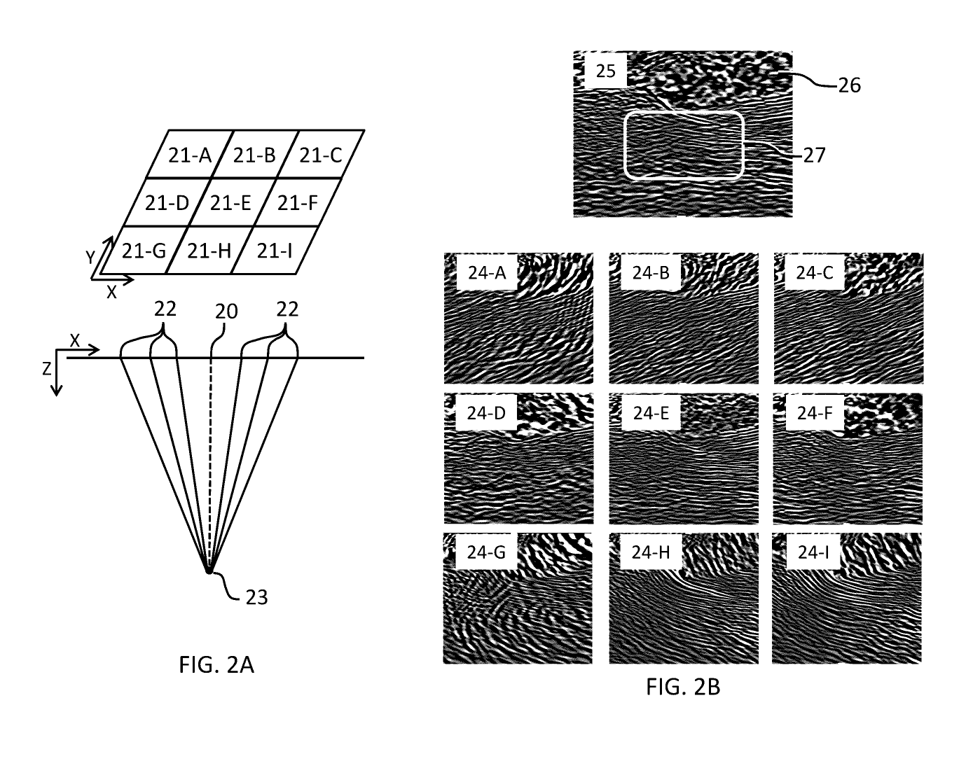

Each shot image is assigned to a vector image partition (VIP) tile at operation 12. This operation is illustrated in FIG. 2A. VIP tiles are defined based on a range of VIP offsets wherein the offset represents the distance from a surface image location 20. In FIG. 2A, there are nine VIP tiles 21-A through 21-I, each covering a user-defined range of VIP offsets. For a subsurface image point 23, a surface image location 20 (X_{img}) is determined. Each shot image has its surface shot location 22 (Xₛ). The VIP offset for each case is calculated as X_{img}-Xₛ which is used for the assignment to the VIP tile. Although this example shows nine VIP tiles, this is not meant to be limiting. There may be more tiles, fewer tiles, or tiles configured in non-square arrays.

FIG. 2B illustrates the shot images in the VIP tiles. Here, a 2D collection of shot images for each tile are displayed as sections 24-A through 24-I, where the letter suffix matches that of the VIP tiles in FIG. 2A. Note that although this figure shows 2D sections, the shot images assigned to a VIP tile will actually be three dimensional. Section 25 is a 2D section of a conventional raw stack. The conventional raw stack section 25 shows a salt body 26 with the typical noisy area 27 beneath. Comparing this with the shot image sections 24-A through 24-I, it is evident that some of the shot image sections contain mostly noise in this subsalt region. In a conventional stack, the energy in all of the shot images would be added together for each subsurface point, meaning that the noise would be added in with the signal. This results in the poor signal-to-noise ratio seen in section 25 as noisy area 27.

Referring again to FIG. 1, method 100 also receives a local geologic structure 13. Determining the local geologic structure can be done in many ways. For example, a geologic model may have been generated, seismic horizons may have been interpreted, or dip attributes may be calculated based on stacked image or other geological interpretation with seismic stratigraphy or tectonics. Any means of determining the local strike and dip of the geologic structure in the subsurface volume of interest may be used.

Given the local geologic structure and the velocity model, method 100 continues on to raytracing upward 14. The raytracing upward 14 may be for a zero-offset (normal) ray or multi-offset rays. In addition, the rays may instead be propagated as beams such as Gaussian beams.

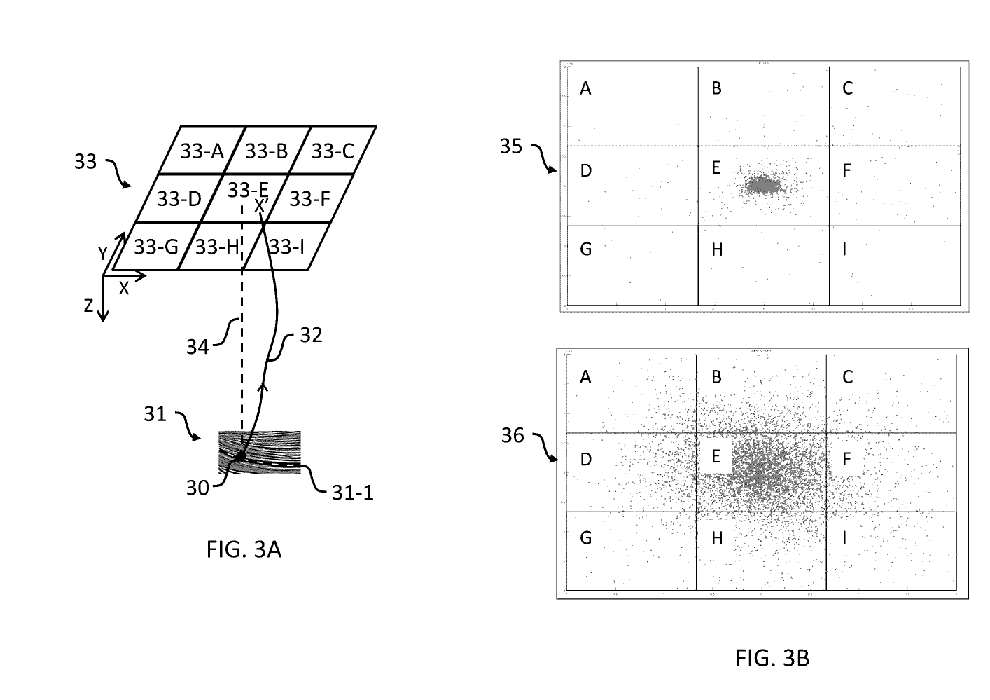

An example of the raytracing upward 14 operation is shown in FIG. 3A. The imaging point 30 is shown superimposed on a small portion of a seismic section 31. A seismic horizon 31-1 has also been interpreted and superimposed on the seismic section 31 as a dashed line. The local geologic structure is assumed to follow seismic horizon 31-1. A normal ray 32 propagates from imaging point 30 to the surface 33. The surface 33 has nine VIP tiles 33-A through 33-I shown. Dashed line 34 shows that the center VIP tile 33-E is centered above the imaging point 30. When the ray reaches surface 33, it emerges into a VIP tile at point X′.

The raytracing may be repeated many times for various imaging points in the subsurface volume of interest. Starting from each imaging point of interest in the subsurface, specular rays are shot up to the surface. Since raytracing may fail in areas with complicated salt boundaries or postcritical regions, it may be advisable to vary the dip within a small angle range (e.g., 5 degrees) to shoot rays as well. Each ray emerges at its own X′ location.

Referring again to FIG. 1, method 100 continues to calculate the ray coverage 15. This ray coverage is based on the plurality of X′ locations from the raytracing upward 14. The ray coverage calculation may use a linear or Gaussian distribution. Moreover, it can be improved based on the amplitude calculation with Gaussian beams along central ray path. FIG. 3B shows two examples of ray coverage in VIP tiles. VIP tiles 35 show the ray coverage from an imaging point that is close to the surface; the letters A-I indicate the individual tiles. VIP tiles 36 show ray coverage from an imaging point that is deep below the surface; once again, the letters A-I indicate the individual tiles. As expected, the ray coverage for the shallow imaging point is concentrated in the central VIP tile E while the deeper imaging point results in broader ray coverage.

For each selected imaging point, after the ray coverage is calculated, each VIP tile is assigned a weight at operation 16 of method 100. The weight can be determined by the ratio of area of linear or Gaussian distribution in a single VIP tile (as found in operation 15) to the complete area. The complete area size can be predefined according to a size-fixed rectangle or circle. It also can be dynamically determined by the amplitude information with Gaussian beams. After the weights are calculated at all selected image locations, different interpolation algorithms can be used to calculate the weights in fine grids.

After the weights are assigned to each VIP tile, the shot images in each VIP tile are scaled according to the weights and stacked together at operation 17. Operation 17 creates a partial image stack, meaning that not all shot images are included. However, due to the steps of method 100, the partial image stack has been optimized to maximize the signal-to-noise ratio. This results in a superior seismic image that is better for seismic interpretation and delineation of potential hydrocarbon reservoirs in the subsurface.

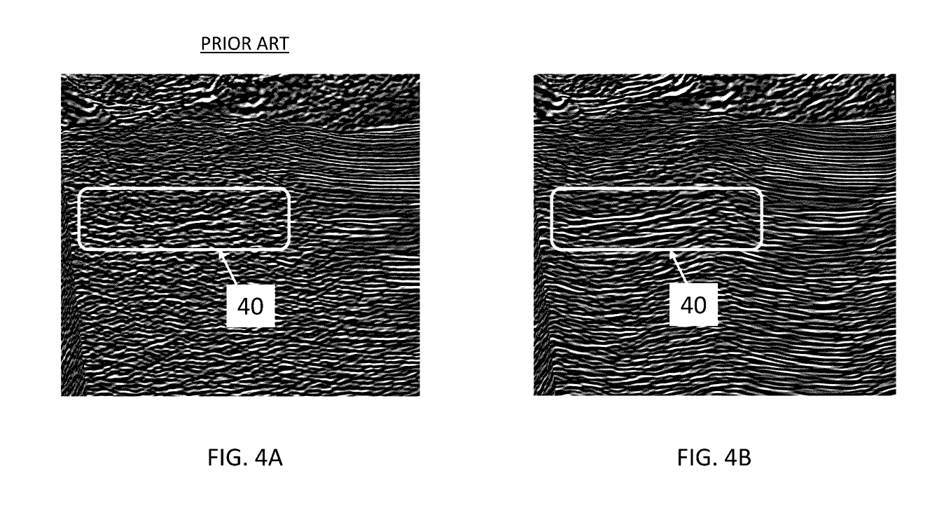

FIGS. 4A and 4B illustrate the improved seismic image. FIG. 4A is the seismic image resulting from a conventional seismic imaging process with conventional stacking. FIG. 4B is the seismic image from the optimized partial image stack of the present invention. The improvement is particularly noticeable in region 40.

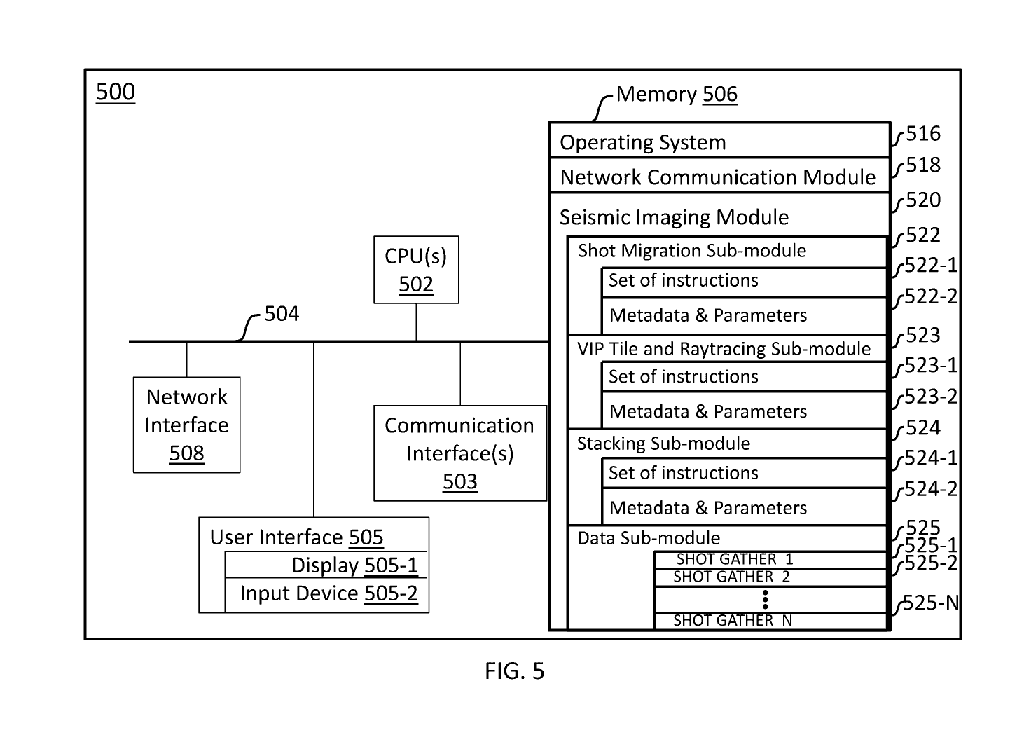

FIG. 5 is a block diagram illustrating a seismic imaging system 500, in accordance with some embodiments. While certain specific features are illustrated, those skilled in the art will appreciate from the present disclosure that various other features have not been illustrated for the sake of brevity and so as not to obscure more pertinent aspects of the embodiments disclosed herein.

To that end, the seismic imaging system 500 includes one or more processing units (CPUs) 502, one or more network interfaces 508 and/or other communications interfaces 503, memory 506, and one or more communication buses 504 for interconnecting these and various other components. The seismic imaging system 500 also includes a user interface 505 (e.g., a display 505-1 and an input device 505-2). The communication buses 504 may include circuitry (sometimes called a chipset) that interconnects and controls communications between system components. Memory 506 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 506 may optionally include one or more storage devices remotely located from the CPUs 502. Memory 506, including the non-volatile and volatile memory devices within memory 506, comprises a non-transitory computer readable storage medium and may store seismic data, velocity models, seismic images, and/or geologic structure information.

In some embodiments, memory 506 or the non-transitory computer readable storage medium of memory 506 stores the following programs, modules and data structures, or a subset thereof including an operating system 516, a network communication module 518, and a seismic imaging module 520.

The operating system 516 includes procedures for handling various basic system services and for performing hardware dependent tasks.

The network communication module 518 facilitates communication with other devices via the communication network interfaces 508 (wired or wireless) and one or more communication networks, such as the Internet, other wide area networks, local area networks, metropolitan area networks, and so on.

In some embodiments, the seismic imaging module 520 executes the operations of method 100. Seismic imaging module 520 may include data sub-module 525, which handles the seismic dataset including shot gathers 525-1 through 525-N. This seismic data is supplied by data sub-module 525 to other sub-modules.

Shot migration sub-module 522 contains a set of instructions 522-1 and accepts metadata and parameters 522-2 that will enable it to execute operation 11 of method 100. The shot migration sub-module 522 migrates each shot in the seismic dataset to create a plurality of shot images. The plurality of shot images may be passed to the VIP tile and raytracing sub-module 523. The VIP tile and raytracing sub-module 523 contains a set of instructions 523-1 and accepts metadata and parameters 532-2 that will enable it to execute, for example, operations 12 and 14-16 of method 100. The stacking sub-module 524 contains a set of instructions 524-1 and accepts metadata and parameters 524-2 that will enable it to execute at least operation 17 of method 100. Although specific operations have been identified for the sub-modules discussed herein, this is not meant to be limiting. Each sub-module may be configured to execute operations identified as being a part of other sub-modules, and may contain other instructions, metadata, and parameters that allow it to execute other operations of use in processing seismic data and generate the seismic image. For example, any of the sub-modules may optionally be able to generate a display that would be sent to and shown on the user interface display 505-1. In addition, any of the seismic data or processed seismic data products may be transmitted via the communication interface(s) 503 or the network interface 508 and may be stored in memory 506.

Method 100 is, optionally, governed by instructions that are stored in computer memory or a non-transitory computer readable storage medium (e.g., memory 506 in FIG. 5) and are executed by one or more processors (e.g., processors 502) of one or more computer systems. The computer readable storage medium may include a magnetic or optical disk storage device, solid state storage devices such as flash memory, or other non-volatile memory device or devices. The computer readable instructions stored on the computer readable storage medium may include one or more of: source code, assembly language code, object code, or another instruction format that is interpreted by one or more processors. In various embodiments, some operations in each method may be combined and/or the order of some operations may be changed from the order shown in the figures. For ease of explanation, method 100 is described as being performed by a computer system, although in some embodiments, various operations of method 100 are distributed across separate computer systems.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method of seismic imaging, comprising:
a. receiving a seismic dataset representative of a subsurface volume of interest and a velocity model;
b. migrating each of a plurality of shots in the seismic dataset to create a plurality of shot images;
c. assigning each of the plurality of shot images to one of a plurality of vector image partition (VIP) tiles;
d. receiving a local geologic structure for an imaging location in the subsurface volume of interest;
e. raytracing, based on the local geologic structure and the velocity model, from the imaging location to a surface above the imaging location, wherein the surface is defined by locations at which the seismic dataset was acquired;
f. calculating ray coverage in each of the VIP tiles based on the raytracing;
g. assigning weights to each of the VIP tiles based on the ray coverage;
h. stacking the plurality of shot images using the assigned weights to create an partial stack seismic image; and
i. identifying geologic features based on the partial stack seismic image.

2. The method of claim 1, wherein the raytracing includes propagation of Gaussian beams.

3. The method of claim 1, wherein the calculating ray coverage is based on linear or Gaussian distributions within each of the VIP tiles.

4. The method of claim 1 further comprising analyzing the geologic features to delineate potential hydrocarbon reservoirs.

5. A computer system, comprising:
one or more processors;
memory; and
one or more programs, wherein the one or more programs are stored in the memory and configured to be executed by the one or more processors, the one or more programs including instructions that when executed by the one or more processors cause the device to:
a. migrate each of a plurality of shots in a seismic dataset to create a plurality of shot images;
b. assign each of the plurality of shot images to one of a plurality of vector image partition (VIP) tiles;
c. raytrace, based on a local geologic structure and a velocity model, from an imaging location to a surface above the imaging location, wherein the surface is defined by locations at which the seismic dataset was acquired;
d. calculate ray coverage in each of the VIP tiles based on the raytracing;
e. assign weights to each of the VIP tiles based on the ray coverage; and
f. stack the plurality of shot images using the assigned weights to create an partial stack seismic image.

6. The system of claim 5, wherein the instructions for the raytracing includes propagation of Gaussian beams.

7. The system of claim 5, wherein the instructions for calculating ray coverage is based on linear or Gaussian distributions within each of the VIP tiles.

8. The system of claim 5 further comprising instructions for analyzing the geologic features to delineate potential hydrocarbon reservoirs.

9. A non-transitory computer readable storage medium storing one or more programs, the one or more programs comprising instructions, which when executed by an electronic device with one or more processors and memory, cause the device to:
a. receive a seismic dataset representative of a subsurface volume of interest and a velocity model;
b. migrate each of a plurality of shots in the seismic dataset to create a plurality of shot images;
c. assign each of the plurality of shot images to one of a plurality of vector image partition (VIP) tiles;
d. receive a local geologic structure for an imaging location in the subsurface volume of interest;
e. raytrace, based on the local geologic structure and the velocity model, from the imaging location to a surface above the imaging location, wherein the surface is defined by locations at which the seismic dataset was acquired;
f. calculate ray coverage in each of the VIP tiles based on the raytracing;
g. assign weights to each of the VIP tiles based on the ray coverage; and
h. stack the plurality of shot images using the assigned weights to create an partial stack seismic image.
